(19) United States
(12) Patent Application Publication
(10) Pub. No.: US 2006/0003132 A1
(43) Pub. Date: Jan. 5, 2006

(54) Surface covering module having an adhesive barrier membrane

(75) Inventors: Horacio Correia, Lachenaie (CA); Denis Faucher, Chateau-Richer (CA)

Correspondence Address: AKERMAN SENTERFITT, P.O. BOX 3188, WEST PALM BEACH, FL, 33402-3188, US

(73) Assignee: Rinox Inc., Terrebonne (CA)

(21) Appl. No.: 11/159,462

(22) Filed: Jun. 22, 2005

(30) Foreign Application Priority Data
Jun. 22, 2004 (CA) 2,471,983

(51) Int. Cl. B32B 9/00

(52) U.S. Cl. 428/40.1; 428/172; 428/47; 428/44

(57) ABSTRACT

Disclosed herein is a module for covering a surface. The module comprises a decorative front face and a back surface-mounting face opposite said front face. The back surface-mounting comprises a heat-softening adhesive barrier membrane. When the adhesive barrier membrane is heat-softened it provides for the surface-mounting face to be adhered to the surface.

### CROSS REFERENCE TO RELATED APPLICATIONS

This application claims priority on Canadian patent application number 2,471,983 filed on Jun. 22, 2004 which is herein incorporated by reference.

### FIELD OF THE INVENTION

The present invention relates to modules for covering surfaces. More specifically, the present invention is concerned with surface covering module having an adhesive barrier membrane.

### BACKGROUND OF THE INVENTION

Surface covering modules such as decorative bricks, tiles and the like are popular commercial products.

Decorative tiles, such as bathroom tiles for example, having adhesive that are can be either self-adhesive or heat-softened to become adhesive are also known in the art. U.S. Pat. Nos. 3,962,504 and 5,989,369 issued to Sherwin on Jun. 8, 1976 and to Light on Nov. 23, 1999 respectively are examples of such decorative tiles.

A drawback of the prior art is that that when adhering modules on a surface such as a ceiling, a floor, and/or a wall extra material for providing a barrier for water, gas, vapor, moisture and/or insulation

### OBJECTS OF THE INVENTION

An object of the present invention is to provide an improved surface-covering module.

Another object of the present invention is to provide an improved surface covering.

A further object of the present invention is to provide an improved method of covering a surface with a surface-covering module.

### SUMMARY OF THE INVENTION

More specifically, in accordance with the present invention, there is provided a module for covering a surface, the module comprising:
a decorative front face; and
a back surface-mounting face opposite the front face and comprising a heat-softening adhesive barrier membrane,
wherein when the adhesive barrier membrane is heat-softened it provides for the surface-mounting face to be adhered to the surface.

In accordance with another aspect of the present invention, there is provided a surface covering comprising modules being mountable to a surface side by side, each module comprising:
a decorative front face; and
a back surface-mounting face opposite the front face and comprising a heat-softening adhesive barrier membrane, the barrier membrane being heat-softenable so as to provide for said surface-mounting face to be adhered to the surface;
peripheral sides adapted to mate with corresponding sides of a similar module disposed adjacent to the module;
wherein when the module and a similar module are adhered side-by-side on the surface, thereby forming a contiguous covering.

In accordance with a further aspect of the present invention, there is provided a method of covering a surface, the method comprising:
(a) providing modules, each module comprising a decorative front face, a back surface-mounting face opposite the front face and comprising a heat-softening adhesive barrier, and peripheral sides adapted to mate with corresponding sides of a similar module disposed adjacent to the module;
(b) heating the heat-softening adhesive barrier membrane so as to become adhesive; and
(c) adhering the modules side-by-side on the surface so that corresponding sides of adjacent modules mate.

In an embodiment, the adhesive barrier membrane is selected from the group consisting of a waterproofing membrane, an gas/vapor barrier membrane, an insulation membrane and a combination thereof.

Definitions:

The term “bitumen” should be construed herein to comprise without limitation residue front atmospheric distillation of crude oil or of a mixture thereof with a slightly oxidized product.

The term “copolymer” should be construed herein to comprise without limitation an elastic polymer which may be formed with ethylene, polyester, polypropylene, polybutyrene, polyimide, polycarbonate, polyamide, polyethylene, polystyrene, polyvinylchloride, fluoroplastics, sulfone polymers, polyvinylidene, chloride, butene, derivatives or mixtures, thereof.

The term “sealing” or “sealed” should be construed herein to comprise without limitation the capacity or property of a material to significantly prevent the passage of a gas or a liquid through a material or a structure

The terms “transudent” or “transuding” should be construed herein to comprise without limitation the capacity or property of a material to transude, to exude, to excrete, to fuse, to transpire, to diffuse, or to pass through pores or interstices of a layer, as a sheet of paper for example. A non transuding material is relatively solid, and does not transude, exude, excrete, transpire, diffuse, or pass through pores or interstices.

The term “waterproofing material” or “water repellant” should be construed herein to comprise without limitation a material that can have the function of gas barrier such as an air barrier for example, vapor barrier, moisture barrier, or combinations thereof.

An advantage of the present invention is that the adhesive barrier material not only allows securely adhering a module on a surface but also provides waterproofing and/or gas/vapor and/or insulation barrier.

Other objects, advantages and features of the present invention will become more apparent upon reading of the following non restrictive description of embodiments thereof, given by way of example only with reference to the accompanying drawings.

### BRIEF DESCRIPTION OF THE DRAWINGS

In the appended drawings where like elements are referenced by like reference numerals and in which:

FIG. 1 is a perspective view of the front face of a module for covering a surface in accordance with an embodiment of the present invention;

FIG. 2 is a perspective view of the back face of the module of FIG. 1;

FIG. 3 is a perspective view of the front face of a module for covering a surface in accordance with another embodiment of the present invention; and

FIG. 4 is a front elevation view of a surface covering surface in accordance with an embodiment of the present invention adhered to a surface.

### DESCRIPTION OF THE EMBODIMENT

With reference to the appended drawings an embodiment of the invention will be herein described so as to exemplify the invention and not limit its scope.

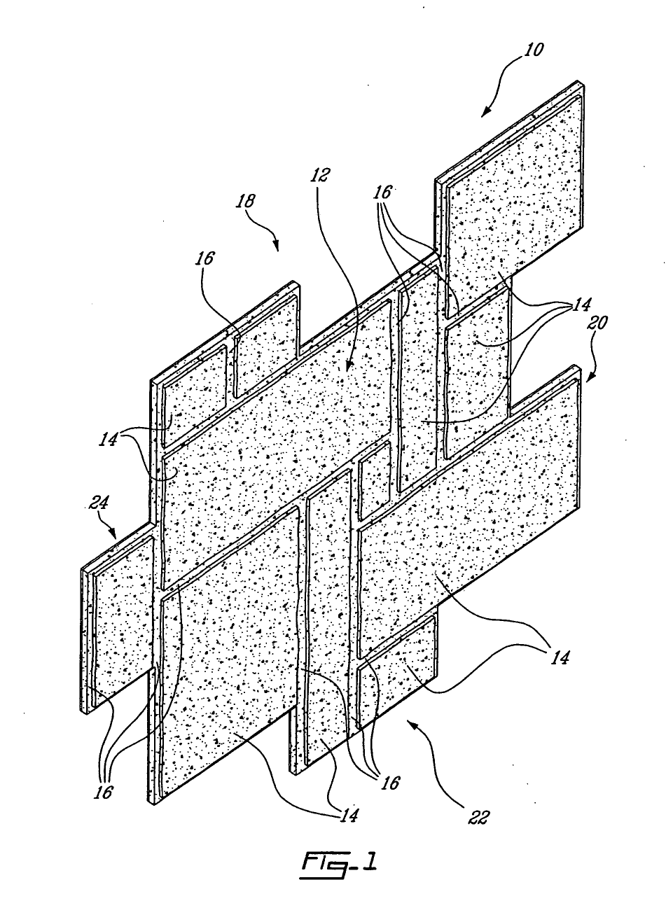

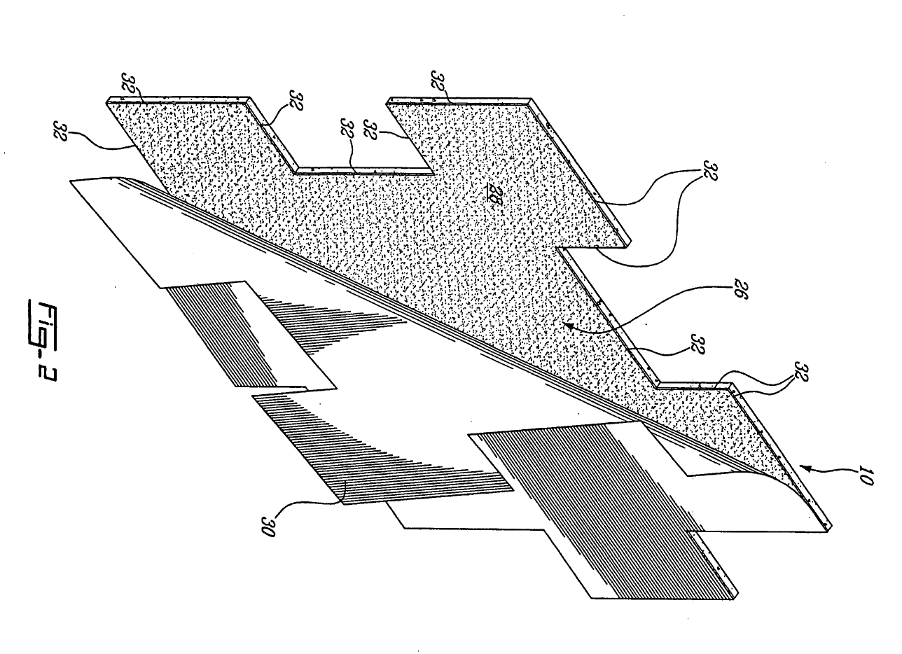

FIGS. 1 and 2 show a module 10 in accordance with an embodiment of the invention adapted to be mounted onto a surface for covering it.

The module 10 has a visible decorative brick face 12. The decorative brick face 12 includes decorative bricks 14 separated by delimiting elements 16. In this example, the delimiting elements 16 are grooves that can receive decorative material therein, as explained hereinafter.

In the example shown here, the module 10 has four jagged-edge sides 18, 20, 22, and 24 respectively.

Sides 18, 20, 22 and 24 are delimited by delimiting elements 16, which in this example are grooves.

With reference to FIG. 2, the module 10 also includes a back surface mounting face 26 that is opposite the front decorative face 12.

The back surface mounting face 26 comprises a heat-softening adhesive barrier membrane 28. The adhesive barrier membrane 28 is covered with a protective film or sheet 30 that can be peeled off.

In the example shown in FIG. 2, the adhesive barrier membrane 28 covers the whole back surface of the module 10 and includes a peripheral edge 32 that is co-linear the edges of sides 18, 20, 22 and 24.

In use, the protective film sheet 30 is peeled off and the adhesive barrier membrane 28 is heat softened until it is rendered adhesive. The module 10 is positioned on a surface (not shown), such as a wall structure for example. In this way, a plurality of modules 10 are adhered on this wall in a side-by-side fashion mating their corresponding adjacent sides 18, 20, 22 and 24 together. Thus, the wall structured is not only covered by a brick-wall facade but it a barrier membrane 28 is simultaneously added along the covered wall.

Grooves 16 are filled with material such as a cemententoius material for example. Since the sides 18, 20, 22, 24, of the modules 10 are bordered by grooves 16, abutting edges will also be filled with material. In this way, the user may create a decorative brick wall surface.

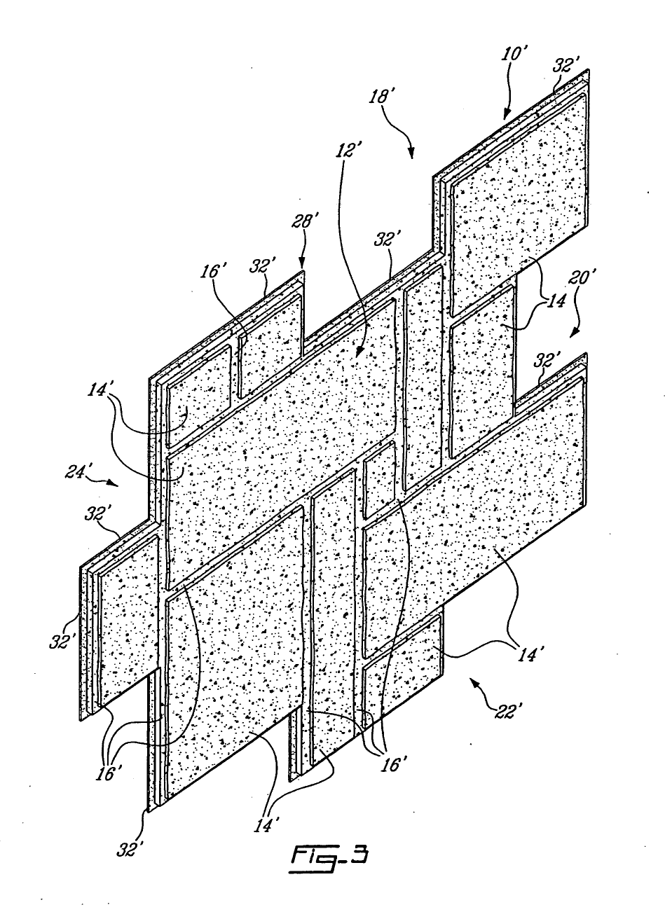

FIG. 3 shows a module 10′ that is similar in construction to module 10 and as such, need not be further described herein for concision purposes only.

Module 10′ comprises a back surface mounting face similar to face 26. In this example the peripheral edge 32′ of adhesive barrier membrane 28′ extends beyond the edges of sides 18′, 20′, 22′ and 24′.

Hence, when covering a surface, such as a wall for example with a plurality of modules 10′ as explained above for modules 10, the extended edges 32′ of two side-by-side modules 10′ mate or even overlap. In this way, any space between to adjacent modules 10′ has been covered by the adhesive barrier membrane.

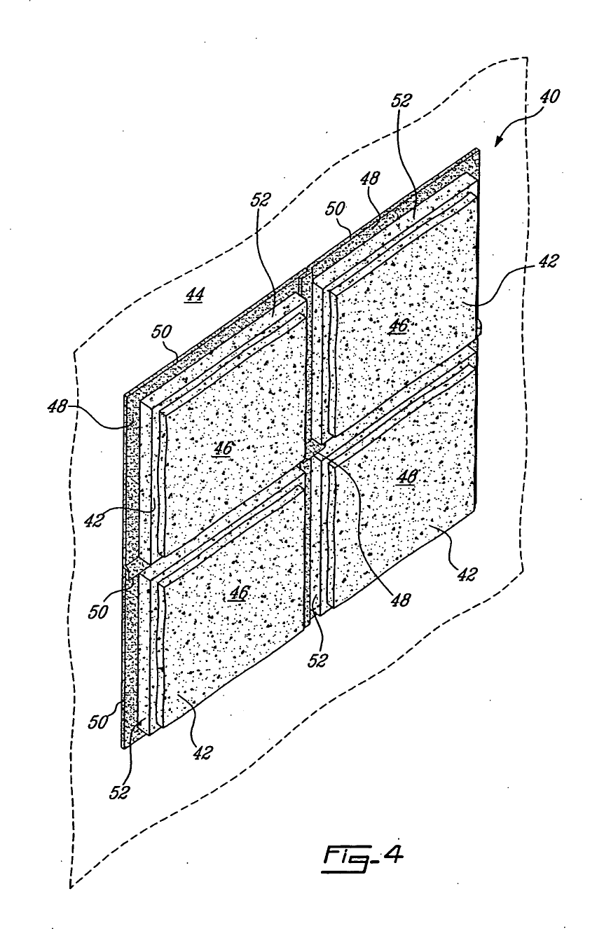

FIG. 4, shows a surface covering 40 comprising modules 42 such as tiles. Tiles 40 are adhered to a surface such as floor 44 in a shower for example with their front decorative faces 46 being exposed. An adhesive barrier membrane 48 is mounted on the back faces (not shown) of the tiles 40. The peripheral edge 50 of the adhesive barrier membrane 48 extends beyond the peripheral sides 52 of the tiles 40. In this way, the extended edges 50 of the membrane 48 of two side-by-side tiles 40 mate or even overlap thus covering any space therebetween.

The heat-softening barrier adhesive membranes 28, 28′, 48 of the present invention may be selected from a variety of waterproofing membranes, gas (such as air) and vapor barrier membranes, insulation membranes and a combinations of the foregoing.

In this way, the adhesive barrier membrane not only permits to adhere surface covering modules to a surface such as a wall or a floor but it also provides waterproofing and/or an gas/vapor barrier and/or insulation.

In one embodiment, the adhesive barrier membrane comprises sealing material and an impervious non-transudent surfacing material.

Furthermore, the adhesive barrier membrane comprises a water repellant or waterproofing material. This water repellant material may be transudent bitumen, transudent polymer, a transudent resin and any other suitable water repellant and/or any combination of the foregoing.

The impervious non-transudent surfacing material can be a polymer, a resin, a plastic, a metal, a polyester, a polypropylene, a polybutyrene, a polyimide, a polycarbonate, a polyamide, a polyethylene, a polystyrene, a polyvinylchloride, a fluoroplastic, a sulfone polymer, and a polyvinylidene chloride.

The sealing material may comprise up to 40% by weight of filler. In an embodiment, the sealing material comprises between 50 to 100% of bitumen, and up to 50% by weight of at least one copolymer. In this way, the combination of bitumen and the copolymer forms 100% of the sealing material.

The bitumen copolymer may be a combination of styrene-butadiene-styrene and a block copolymer.

In an non-limiting example, the softening point of various types of bitumen that can be used within the scope of invention may vary from 36° C. to 140° C. A mixture of various types of bitumen can also be contemplated within the scope of the invention ad the properties of the bitumen can be modified by adding mineral oils, fatty substances and chemical agents.

Of course, the modules of the present invention may be any type of surface covering module as will be understood by the skilled artisan and as such may be constructed by a variety of suitable materials such as a ceramic, cementations material, metal, plastic, wood and combinations of the foregoing or any other type of suitable material.

It is to be understood that the invention is not limited in its application to the details of construction and parts illustrated in the accompanying drawings and described hereinabove. The invention is capable of other embodiments and of being practised in various ways. It is also to be understood that the phraseology or terminology used herein is for the purpose of description and not limitation. Hence, although the present invention has been described hereinabove by way of embodiments thereof, it can be modified, without departing from the spirit, scope and nature of the subject invention as defined in the appended claims.

What is claimed is:

1. A module for covering a surface, said module comprising:
a decorative front face; and
a back surface-mounting face opposite said-front face and comprising a heat-softening adhesive barrier membrane,
wherein when said adhesive barrier membrane is heat-softened it provides for said surface-mounting face to be adhered to the surface.

2. A module according to claim 1, wherein said barrier membrane is selected from the group consisting of a waterproofing membrane, an gas/vapor barrier membrane, an insulation membrane and a combination thereof.

3. A module according to claim 1, wherein said heat-softening adhesive barrier membrane comprises a sealing material and an impervious non-transudent surfacing material.

4. A module according to claim 3, wherein said heat-softening adhesive barrier membrane further comprises a waterproofing material.

5. A module according to claim 3, wherein said sealing material comprises 40% by weight filler.

6. A module according to claim 3, wherein said sealing material comprises from about 50 to 100% by weight of bitumen and from 0 to about 50% by weight of at least one copolymer.

7. A module according to claim 6, wherein said bitumen copolymer combination comprises a styrene-butadiene-styrene and a block copolymer.

8. A module according to claim 3, wherein said impervious non-transudent surfacing material comprises a material selected from the group consisting of a polymer, a resin, a plastic, a metal, a polyester, a polypropylene, a polybutyrene, a polyimide, a polycarbonate, a polyamide, a polyethylene, a polystyrene, a polyvinylchloride, a fluoroplastic, a sulfone polymer, and a polyvinylidene chloride.

9. A module according to claim 4, wherein said waterproofing material comprises a material selected from the group consisting of a transudent bitumen, transudent polymer, a transudent resin or any combination thereof.

10. A module according to claim 1, wherein said surface-mounting face comprises a protective peel-off film covering said barrier membrane.

11. A module according to claim 1, wherein said decorative front face comprises a decorative brick.

12. A module according to claim 1, wherein said module comprises a tile.

13. A module according to claim 1, wherein said decorative front face comprises material selected from the group consisting of wood, metal, ceramic, plastic, cemententious material and a combination thereof.

14. A module according to claim 1, wherein said decorative front face and said back surface-mounting face comprise co-linear respective peripheral edges, said barrier membrane comprising a peripheral edge that extends beyond said co-linear edges.

15. A module according to claim 1, wherein the surface is selected from the group consisting of a wall, a ceiling, a floor and a combination thereof.

16. A module according to claim 1, wherein said decorative front face comprises decorative bricks separated by delimiting elements.

17. A module according to claim 16, wherein said delimiting elements comprise grooves.

18. A module according to claim 17, wherein said grooves are configured to receive cemententious material therein.

19. A module according to claim 16, wherein said module further comprises a number of peripheral sides adapted to mate with corresponding sides of a similar module disposed adjacent to said module.

20. A module according to claim 19, wherein said module is in the form of a panel, said sides being jagged for jigsaw-type assembly on the wall structure of a plurality of said modules.

21. A surface covering comprising modules being mountable to a surface side by side, each said module comprising:
a decorative front face; and
a back surface-mounting face opposite said front face and comprising a heat-softening adhesive barrier membrane, said barrier membrane being heat-softened so as to provide for said surface-mounting face to be adhered to the surface;
peripheral sides adapted to mate with corresponding sides of a similar module disposed adjacent to said module;
wherein when said module and said similar module are adhered side-by-side on the surface, thereby forming a contiguous covering.

22. A surface covering according to claim 20, wherein said barrier membrane is selected from the group consisting of a waterproofing membrane, an gas/vapor barrier membrane, an insulation membrane and a combination thereof.

23. A surface covering according to claim 15, wherein said barrier membrane comprises a sealing material and an impervious non-transudent surfacing material.

24. A module according to claim 23, wherein said heat-softening adhesive barrier membrane further comprises a waterproofing material.

25. A module according to claim 23, wherein said sealing material comprises 40% by weight filler.

26. A module according to claim 23, wherein said sealing material comprises from about 50 to 100% by weight of bitumen and from 0 to about 50% by weight of at least one copolymer.

27. A module according to claim 26, wherein said bitumen copolymer combination comprises a styrene-butadiene-styrene and a block copolymer.

28. A module according to claim 23, wherein said impervious non-transudent surfacing material comprises a material selected from the group consisting of a polymer, a resin, a plastic, a metal, a polyester, a polypropylene, a polybutyrene, a polyimide, a polycarbonate, a polyamide, a polyethylene, a polystyrene, a polyvinylchloride, a fluoroplastic, a sulfone polymer, and a polyvinylidene chloride.

29. A module according to claim 24, wherein said waterproofing material comprises a material selected from the group consisting of a transudent bitumen, transudent polymer, a transudent resin or any combination thereof.

30. A surface covering according to claim 20, wherein said surface-mounting face comprises a protective peel-off film covering said barrier membrane.

31. A surface covering according to claim 20, wherein said decorative front face comprises a decorative brick.

32. A surface covering according to claim 20, wherein said module comprises a tile.

33. A surface covering according to claim 20, wherein said decorative front face comprises material selected from the group consisting of wood, metal, ceramic, plastic, cemententious material and a combination thereof.

34. A surface covering according to claim 20, wherein said exposed front face and said back surface-mounting face comprise co-linear respective peripheral edges, said heat-softening adhesive material comprising a peripheral edge that extends beyond said co-linear edges.

35. A surface covering according to claim 20, wherein the surface is selected from the group consisting of a wall, a ceiling and a floor.

36. A surface covering according to claim 20, wherein said exposed front face comprises a decorative face, said decorative face comprising decorative bricks separated by delimiting elements.

37. A surface covering according to claim 36, wherein said delimiting elements comprise grooves.

38. A surface covering according to claim 36, wherein said grooves are configured to receive cemententious material therein.

39. A surface covering according to claim 20, wherein said module is in the form of a panel, said sides being jagged for jigsaw-type assembly on the wall structure of a plurality of said modules.

40. A surface covering according to claim 20, wherein said barrier membrane comprises a peripheral edge that extends beyond said peripheral sides, providing for adjacent said membrane peripheral edges of two respective side-by-side module to mate.

41. A surface covering according to claim 40, wherein said mating adjacent membrane peripheral edges overlap.

42. A method of covering a surface, said method comprising:
(a) providing modules, each module comprising an decorative front face, a back surface-mounting face opposite said front face and comprising a heat-softening adhesive barrier, and peripheral sides adapted to mate with corresponding sides of a similar module disposed adjacent to said module;
(b) heating said heat-softening adhesive barrier membrane so as to become adhesive; and
(c) adhering said modules side-by-side on the surface so that corresponding sides of adjacent modules mate.

43. A method according to claim 42, further comprising peeling-off a protective sheet covering said barrier membrane before step b).

44. A method according to claim 42, wherein said adhesive barrier membrane comprises a peripheral edge that extends beyond said peripheral sides, step c) comprising mating and adjacent membrane peripheral edges of two respective side-by-side module.

45. A method according to claim 44, wherein said mating comprises overlapping.

46. A method according to claim 42, wherein said barrier membrane is selected from the group consisting of a waterproofing membrane, an gas/vapor barrier membrane, an insulation membrane and a combination thereof.

47. A method according to claim 42, wherein said adhesive barrier membrane comprises a sealing material and an impervious non-transudent surfacing material.

48. A module according to claim 47, wherein said heat-softening adhesive barrier membrane further comprises a waterproofing material.

49. A module according to claim 47, wherein said sealing material comprises 40% by weight filler.

50. A module according to claim 47, wherein said sealing material comprises from about 50 to 100% by weight of bitumen and from 0 to about 50% by weight of at least one copolymer.

51. A module according to claim 50, wherein said bitumen copolymer combination comprises a styrene-butadiene-styrene and a block copolymer.

52. A module according to claim 47, wherein said impervious non-transudent surfacing material comprises a material selected from the group consisting of a polymer, a resin, a plastic, a metal, a polyester, a polypropylene, a polybutyrene, a polyimide, a polycarbonate, a polyamide, a polyethylene, a polystyrene, a polyvinylchloride, a fluoroplastic, a sulfone polymer, and a polyvinylidene chloride.

53. A module according to claim 48, wherein said waterproofing material comprises a material selected from the group consisting of a transudent bitumen, transudent polymer, a transudent resin or any combination thereof.
